(19) United States
(12) Patent Application Publication
(10) Pub. No.: US 2025/0247487 A1
(43) Pub. Date: Jul. 31, 2025

(54) IMAGE PROCESSING APPARATUS AND CONTROL METHOD

(71) Applicant: CANON KABUSHIKI KAISHA, Tokyo (JP)

(72) Inventor: YOSHIHIDE TERAO, Kanagawa (JP)

(21) Appl. No.: 19/035,612

(22) Filed: Jan. 23, 2025

(30) Foreign Application Priority Data
Jan. 29, 2024 (JP) 2024-011044

(51) Int. Cl. H04N 1/44; H04L 9/32

(52) U.S. Cl. CPC H04N 1/4433; H04L 9/3213

(57) ABSTRACT

An image processing apparatus including a scanner and a storage device configured to save one or more jobs receives, from an information processing apparatus, a scan job including a scan setting, a transmission destination of image data to be obtained in a reading process by the scanner based on the scan setting, and a token acquired from an authorization server to access the transmission destination, saves the received scan job in the storage device, identifies, based on a user operation via an operation unit of the image processing apparatus, a target scan job from the storage device, and executes a transmission process based on image data obtained by executing the identified scan job and a token and a transmission destination included in the identified scan job.

### BACKGROUND

### Field

The present disclosure relates to a scanning process in an image processing apparatus.

### Description of the Related Art

In recent years, there are an increasing number of cases where a storage server on a cloud is used as the save location of an image scanned by an image processing apparatus such as a scanner or a multifunction peripheral. There are also an increasing number of workflows of scanning in which an image processing apparatus and a cloud service cooperate with each other.

However, in a case where a document scanned by an image processing apparatus is uploaded to a cloud service, a user specifies the resolution and the save location in the image processing apparatus. Thus, the upload operation is cumbersome and takes time. Particularly, in a case where the image processing apparatus is a shared device, the operation time in the device should be made as short as possible.

Japanese Patent Application Laid-Open No. 2017-135691 discusses a technique for a user to simply specify the resolution and the save location when a scanned document is uploaded to a cloud service. Japanese Patent Application Laid-Open No. 2017-135691 discusses a technique in which information regarding scan settings and a cloud service and authentication information are held in an external service on a network, and an image processing apparatus can perform scanning using the held information and upload a scanned document to the cloud service.

However, in a method for saving scan settings in an external service on a network as in the publication of Japanese Patent Application Laid-Open No. 2017-135691, it is necessary to separately construct the external service on the network. This is a massive configuration, and therefore, the method cannot be easily introduced.

### SUMMARY

According to an aspect of the present disclosure, an image processing apparatus includes a scanner, a storage device configured to save one or more jobs, one or more memories storing a program, and one or more processors that, when executing the program, cause the image processing apparatus to receive, from an information processing apparatus, a scan job including a scan setting, a transmission destination of image data to be obtained in a reading process by the scanner based on the scan setting, and a token acquired from an authorization server to access the transmission destination, save the received scan job in the storage device, identify, based on a user operation via an operation unit of the image processing apparatus, a target scan job from the storage device, and execute a transmission process based on image data obtained by executing the identified scan job and a token and a transmission destination included in the identified scan job.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a system according to a first exemplary embodiment.

FIG. 2 is a block diagram illustrating examples of details of a controller unit of a multifunction peripheral (MFP) according to the present exemplary embodiment.

FIG. 3 is a block diagram illustrating examples of details of an authorization server or a storage server according to the present exemplary embodiment.

FIG. 4 is a block diagram illustrating examples of details of a client terminal according to the present exemplary embodiment.

FIG. 5 is a block diagram illustrating an example of a software configuration of the MFP according to the present exemplary embodiment.

FIG. 6 is a diagram illustrating an example of a sequence in which the client terminal acquires an access token for accessing the storage server and sets a save location according to the present exemplary embodiment.

FIG. 7 is a diagram illustrating an example of an authorization screen according to the present exemplary embodiment.

FIG. 8A is a flowchart illustrating an example of processing of the client terminal according to the present exemplary embodiment.

FIG. 8B is a flowchart illustrating an example of processing of the MFP according to the present exemplary embodiment.

FIG. 9 is a diagram illustrating an example of a “reservation scan settings” screen according to the present exemplary embodiment.

FIG. 10 is a diagram illustrating an example of a data configuration when a reservation scan job is saved according to the present exemplary embodiment.

FIG. 11 is a flowchart illustrating an example of a process in which the MFP executes a reservation scan job according to the present exemplary embodiment.

FIGS. 12A to 12D are diagrams illustrating examples of screens when a reservation scan job is executed according to the present exemplary embodiment.

FIG. 13A is a flowchart illustrating an example of processing of a client terminal according to a second exemplary embodiment.

FIG. 13B is a flowchart illustrating an example of processing of an MFP according to the second exemplary embodiment.

### DESCRIPTION OF THE EMBODIMENTS

Exemplary embodiments of the present disclosure will be described below based on the drawings. However, not all the features described in the present exemplary embodiments are essential for a method for solving the issues in the present disclosure. In the exemplary embodiments of the present disclosure, a description is given of an example of a service where an image forming apparatus cooperates with a client terminal such as a personal computer (PC) or a smartphone, an authorization server, and a storage server.

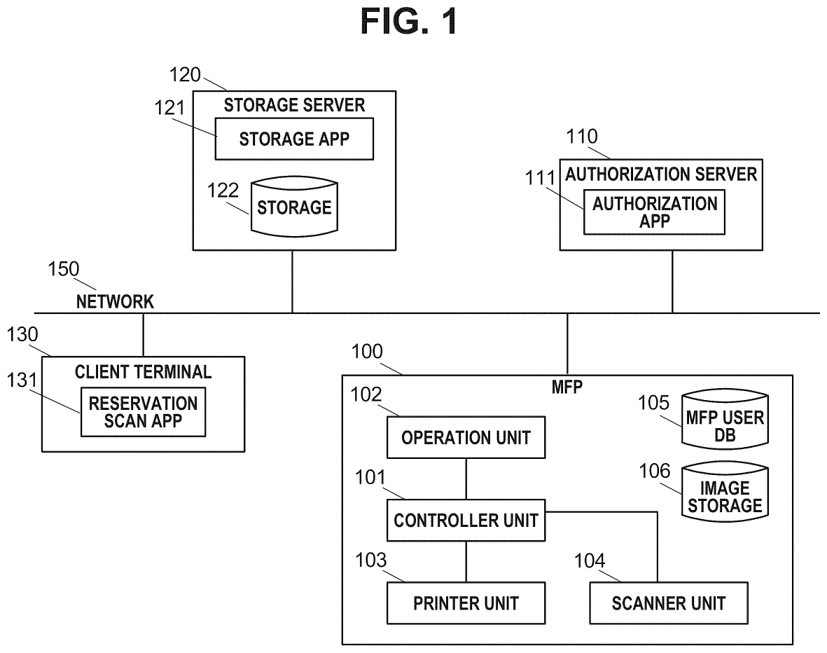

FIG. 1 is a diagram illustrating an example of the configuration of a system according to a first exemplary embodiment of the present disclosure.

The system according to the present exemplary embodiment includes a multifunction peripheral (MFP) 100, an authorization server 110, a storage server 120, and a client terminal 130. The MFP 100, the authorization server 110, the storage server 120, and the client terminal 130 are connected to each other via a network 150 so that these apparatuses can communicate with each other.

The network 150 may use either a wired connection or a wireless connection, and may be either the Internet or an intranet. For example, the network 150 may be in any form such as a wireless connection, Wi-Fi®, or a data communication line so long as data can be exchanged via the network 150. Not all networks to which the MFP 100, the authorization server 110, the storage server 120, and the client terminal 130 are connected may be of the same network type. For example, a form is possible in which the MFP 100, the authorization server 110, and the storage server 120 are connected to the Internet by wire, and the client terminal 130 is connected to the Internet via a data communication line.

The MFP 100 is an image processing apparatus (a multifunction peripheral). The MFP 100 can read an image using a scanner and print an image using a printer. The MFP 100 includes an operation unit 102 that receives an input from and provides an output to a user. The MFP 100 includes a printer unit 103 that outputs electronic data to a paper medium. The MFP 100 includes a scanner unit 104 that reads an image from a paper medium and converts the image into electronic data. The operation unit 102, the printer unit 103, and the scanner unit 104 are connected to a controller unit 101 and achieve functions as a multifunction peripheral according to control of the controller unit 101. The MFP 100 includes an MFP user database (DB) 105 and image storage 106. The MFP user DB 105 stores information regarding an MFP user for performing authentication when the MFP 100 is used. The image storage 106 is composed of a temporary area where temporary image data such as data used by the printer unit 103 and data converted by the scanner unit 104 is saved, and a long-term storage area where image data that needs to be stored for a longer period than the temporary image data is saved.

The authorization server 110 includes an authorization application (hereinafter “authorization app”) 111. In the present exemplary embodiment, for example, an example is illustrated where the authorization app 111 follows the mechanism of open authorization (OAuth) defined by Request for Comments (RFC) 6479. If the client terminal 130 requests access to the storage server 120 with appropriate authentication information, the authorization app 111 issues an access token for giving authority to access the storage server 120. If the client terminal 130 transmits the access token to the storage server 120 and requests access, the storage server 120 confirms the validity of the access token with the authorization server 110. At this time, the authorization app 111 determines whether the access token is valid. Since the validity period of the access token is generally a short time, the authorization app 111 may issue a refresh token having a longer validity period to update the access token. If the client terminal 130 makes a request to update the access token using the refresh token, the authorization app 111 reissues an access token and a refresh token and returns the access token and the refresh token to the client terminal 130.

OAuth is merely an example, and authorization and authentication may be performed using another method. The authorization server 110 is configured using a known technique, and therefore is not described in detail.

For example, the storage server 120 is cloud storage and includes a storage application (hereinafter “storage app”) 121 and storage 122. The storage app 121 receives an instruction from the client terminal 130 and returns lists of files and directories stored in the storage 122 or saves a file in the storage 122. If the storage app 121 receives an access token from the client terminal 130, the storage app 121 confirms with the authorization server 110 whether the access token is valid. If the access token is not valid, the storage app 121 rejects access from the client terminal 130. The storage server 120 is configured using a known technique, and therefore is not described in detail.

The client terminal 130 includes a reservation scan application (hereinafter “reservation scan app”) 131. Although FIG. 1 illustrates only a single client terminal 130, a plurality of client terminals 130 may exist. The reservation scan app 131 makes scan settings for performing scanning in the MFP 100, sets the save location of a scanned image file, and instructs the MFP 100 to issue a reservation scan job. Examples of the client terminal 130 include information processing apparatuses such as a smartphone, a tablet, and a personal computer (PC). Since FIG. 1 illustrates only components for describing the present exemplary embodiment, a component other than these components may be included so long as the present exemplary embodiment can be achieved. Moreover, the connection forms between the components are not limited to these.

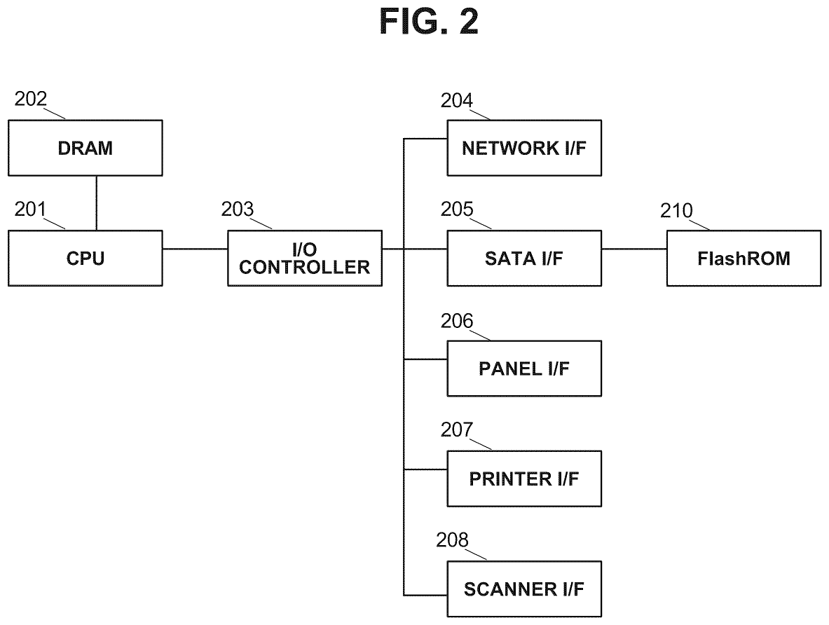

FIG. 2 is a block diagram illustrating examples of the details of the controller unit 101 of the MFP 100.

A central processing unit (CPU) 201 performs a main calculation process in a controller. The CPU 201 is connected to a dynamic random-access memory (DRAM) 202 via a bus. The DRAM 202 is used by the CPU 201 as a work memory for temporarily placing program data indicating a calculation command during the process in which the CPU 201 performs calculation and processing target data.

The CPU 201 is connected to an input/output (I/O) controller 203 via the bus. According to an instruction from the CPU 201, the I/O controller 203 transmits an input to and receives an output from various devices. To the I/O controller 203, a Serial Advanced Technology Attachment (SATA) interface (I/F) 205 is connected. To the SATA I/F 205, a flash read-only memory (ROM) 210 is connected. The CPU 201 uses the flash ROM 210 to permanently store programs for achieving the functions of the MFP 100 and a document file. To the SATA I/F 205, a large-capacity storage device such as a hard disk drive (HDD) may be connected instead of the flash ROM 210.

To the I/O controller 203, a network I/F 204 is also connected. To the network I/F 204, a wired local area network (LAN) device or a wireless LAN device is connected. The CPU 201 controls the wired LAN device or the wireless LAN device via the network I/F 204, thereby achieving communication on the network 150.

To the I/O controller 203, a panel I/F 206 is also connected. The CPU 201 achieves an input from and an output to the user via the operation unit 102 via the panel I/F 206.

To the I/O controller 203, a printer I/F 207 is also connected. The CPU 201 achieves a process of outputting a paper medium using the printer unit 103 via the printer I/F 207.

To the I/O controller 203, a scanner I/F 208 is also connected. The CPU 201 achieves a process of reading an image from an original document using the scanner unit 104 via the scanner I/F 208.

In the MFP 100, various applications for using the functions of the MFP 100 are present.

Examples of the functions include a copy function, a transmission function, a fax function, and a box function.

For example, in a case where the copy function is executed, the CPU 201 reads program data from the flash ROM 210 into the DRAM 202 via the SATA I/F 205. According to the program read into the DRAM 202, the CPU 201 detects, via the panel I/F 206, a copy instruction given via the operation unit 102 by the user. If the CPU 201 detects the copy instruction, the CPU 201 receives an original document as electronic data from the scanner unit 104 via the scanner I/F 208 and stores the electronic data in the DRAM 202. The CPU 201 performs a color conversion process suitable for output on this image data stored in the DRAM 202. The CPU 201 transfers the image data stored in the DRAM 202 to the printer unit 103 via the printer I/F 207 and performs a process of outputting the image data to a paper medium.

In the transmission function, a process in which the CPU 201 detects a transmission instruction from the user is similar to the process in which the CPU 201 detects a copy instruction in the copy function. The transmission instruction includes a transmission protocol, the specifying of a transmission destination, and an image format from the user. The transmission protocol is Server Message Block (SMB), the File Transfer Protocol (FTP), or email (the Simple Mail Transfer Protocol (SMTP)). In the specifying of the transmission destination, for example, the transmission destination is specified based on a Universal Naming Convention (UNC). The image format is the Joint Photographic Experts Group (JPEG) or Portable Document Format (PDF). If the CPU 201 detects the transmission instruction, the CPU 201 receives an original document as electronic data from the scanner unit 104 via the scanner I/F 208 and stores the electronic data in the DRAM 202. The CPU 201 converts this image data stored in the DRAM 202 into the image format specified by the user. The CPU 201 transfers the image data stored in the DRAM 202 to the transmission destination via the network I/F 204 using the protocol specified by the user. At this time, the CPU 201 can specify the storage server 120 as the transmission destination and transmit the image data using an authorization mechanism that uses an access token.

In the fax function, a process in which the CPU 201 detects a fax instruction from the user is similar to the process in which the CPU 201 detects a copy instruction in the copy function. If the CPU 201 detects the fax instruction, the CPU 201 receives an original document as electronic data from the scanner unit 104 via the scanner I/F 208 and stores the electronic data in the DRAM 202. The CPU 201 converts this image data stored in the DRAM 202 into an image format for fax. The CPU 201 transfers the image data stored in the DRAM 202 to a telephone number for fax specified in the fax instruction via a telephone line network (not illustrated). The fax via the telephone line is merely an example, and Internet fax can also be used.

The box function is a function in which a scanned image is saved in a storage area within the MFP 100 or a memory medium connected to the MFP 100, or the MFP 100 serves as a file server, thereby disclosing an image saved in the MFP 100 to an external PC or another image processing apparatus (not illustrated). In the box function, a process in which the CPU 201 detects a box saving instruction from the user is similar to the process in which the CPU 201 detects a copy instruction in the copy function. The box saving instruction includes the specifying of a save location and an image format from the user. The save location is the path to storage within the MFP 100 or a memory medium connected to the MFP 100. The image format is the JPEG or PDF, for example. If the CPU 201 detects the box saving instruction, the CPU 201 receives an original document as electronic data from the scanner unit 104 via the scanner I/F 208 and stores the electronic data in the DRAM 202. The CPU 201 converts this image data stored in the DRAM 202 into the image format specified by the user. The CPU 201 transfers the image data stored in the DRAM 202 to the save location specified by the user, such as the flash ROM 210 within the MFP 100 or a memory medium (not illustrated), via the SATA I/F 205.

In the fax function, a received image may not be printed, but may be converted into a format in which the received image can be viewed on a PC, and may be saved in a box. As the box function, the MFP 100 serves as a file server such as an SMB server, thereby disclosing the content of the flash ROM 210. In the box function, the CPU 201 detects a box access instruction from outside via the network I/F 204. The box access instruction includes an image file path to an access destination. The CPU 201 transfers image data stored in the flash ROM 210 corresponding to the specified image file path to the request source of the box access instruction via the network I/F 204.

The above functions of the MFP 100 are merely examples, and the MFP 100 may have another function.

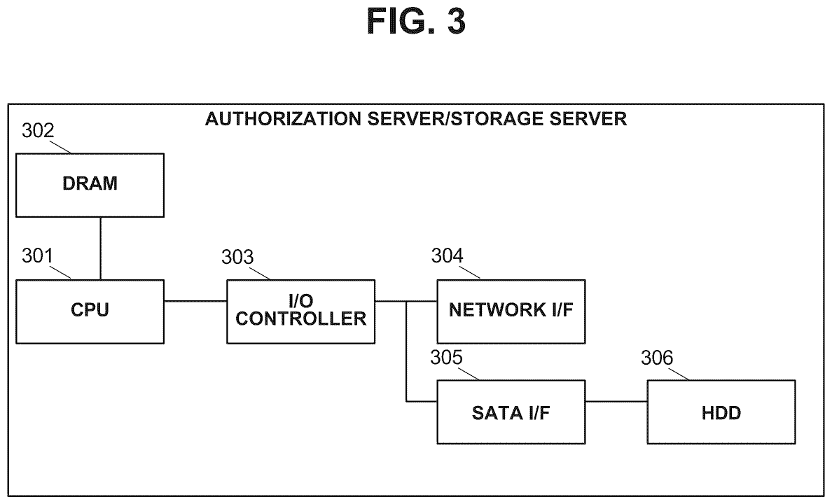

FIG. 3 is a block diagram illustrating examples of the details of the authorization server 110 or the storage server 120 according to the present exemplary embodiment. Although the authorization server 110 and the storage server 120 have the same configuration for ease of description in the present exemplary embodiment, the authorization server 110 and the storage server 120 may have different configurations. For example, the authorization server 110 and the storage server 120 may have configurations achieved using a cloud computing technique.

A CPU 301 is connected to a DRAM 302 via a bus. The DRAM 302 is used by the CPU 301 as a work memory for temporarily placing program data indicating a calculation command during the process in which the CPU 301 performs calculation and processing target data.

The CPU 301 is connected to an I/O controller 303 via the bus.

To the I/O controller 303, a network I/F 304 is connected. To the network I/F 304, a wired LAN device or a wireless LAN device is connected. The CPU 301 controls the wired LAN device or the wireless LAN device via the network I/F 304, thereby achieving communication on the network 150.

According to an instruction from the CPU 301, the I/O controller 303 also transmits an input to and receives an output from various devices. To the I/O controller 303, a SATA I/F 305 is connected. To the SATA I/F 305, an HDD 306 is connected. In the case of the authorization server 110, the CPU 301 uses the HDD 306 to permanently store a program and a setting value for the authorization app 111. In the case of the storage server 120, the CPU 301 uses the HDD 306 to permanently store a program and a setting value for the storage app 121. A configuration may be employed in which another storage device such as a solid-state drive (SSD) or an embedded MultiMediaCard (eMMC) may be included instead of or in combination with the HDD 306.

The hardware such as the CPU 301, the DRAM 302, and the HDD 306 thus forms a so-called computer. Although in the present exemplary embodiment, for illustrative purposes, a case is illustrated where a single CPU 301 executes processes illustrated in flowcharts described below using a single memory (the DRAM 302), another form may be employed. For example, a plurality of processors, RAMs, ROMs, and spaces of storage can also cooperate to execute the processes illustrated in the flowcharts described below. Alternatively, the processes can also be executed using a plurality of server computers.

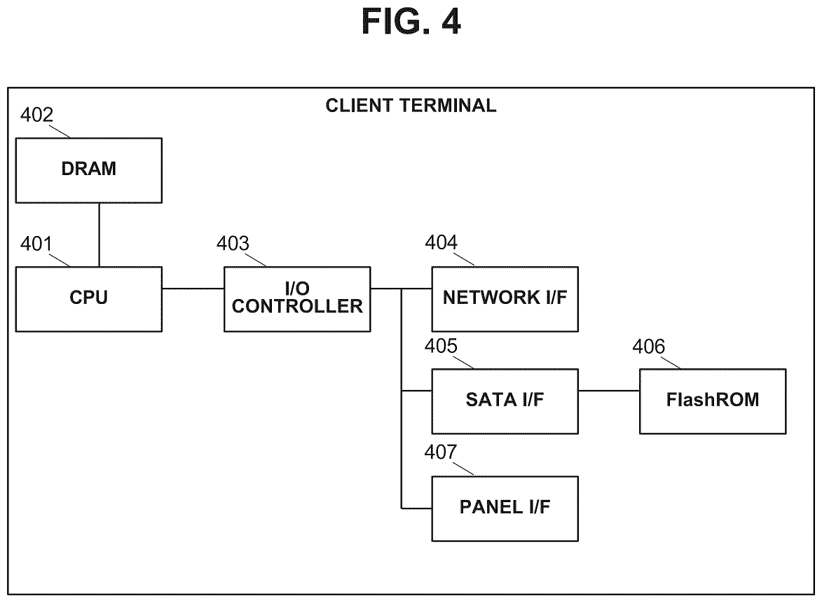

FIG. 4 is a block diagram illustrating examples of the details of the client terminal 130 according to the present exemplary embodiment.

A CPU 401 is connected to a DRAM 402 via a bus. The DRAM 402 is used by the CPU 401 as a work memory for temporarily placing program data indicating a calculation command during the process in which the CPU 401 performs calculation and processing target data.

The CPU 401 is connected to an I/O controller 403 via the bus.

To the I/O controller 403, a network I/F 404 is connected. To the network I/F 404, a wired LAN device, a wireless LAN device, or a data communication device is connected. The CPU 401 controls the wired LAN device, the wireless LAN device, or the data communication device via the network I/F 404, thereby achieving communication on the network 150. According to an instruction from the CPU 401, the I/O controller 403 transmits an input to and receives an output from various devices.

To the I/O controller 403, a SATA I/F 405 is also connected. To the SATA I/F 405, a flash ROM 406 is connected. A configuration may be employed in which another storage device such as an HDD instead of the flash ROM 406 is connected to the SATA I/F 405. The CPU 401 uses the flash ROM 406 to permanently store a program and a setting value for the reservation scan app 131.

To the I/O controller 403, a panel I/F 407 is also connected. The CPU 401 achieves an input from and an output to the user via an operation unit (not illustrated) of the client terminal 130 connected to the CPU 401 via the panel I/F 407. A touch panel is an example of the operation unit. A display device such as a display that performs display and an input device such as a keyboard that provides an input may be connected to the panel I/F 407.

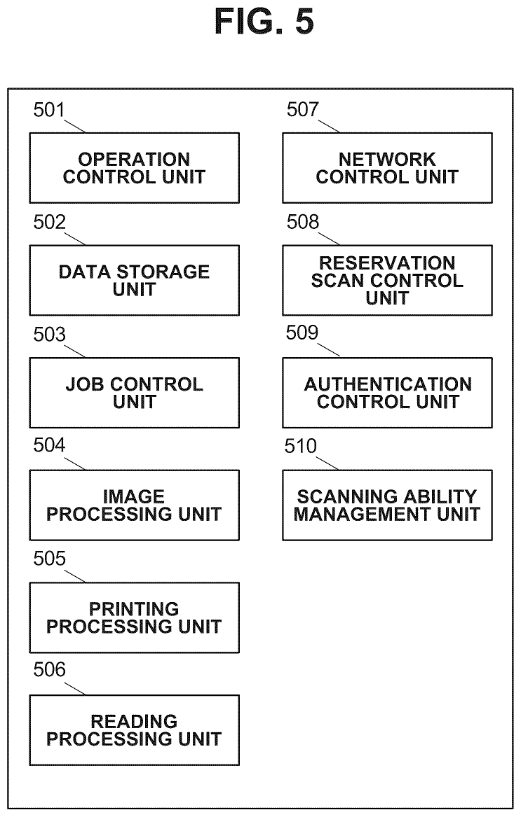

FIG. 5 is a block diagram illustrating an example of the configuration of software executed by the controller unit 101 of the MFP 100. The software executed by the controller unit 101 is all executed after the CPU 201 reads programs stored in the flash ROM 210 into the DRAM 202. Thus, the software achieves functional units 501 to 510 as illustrated in FIG. 5.

An operation control unit 501 displays a screen image for the user on the operation unit 102, detects a user operation, and executes a process associated with a screen component such as a button displayed on the screen.

A data storage unit 502 stores a request from another control unit in the flash ROM 210 and reads the request from the flash ROM 210.

According to an instruction from another control unit, a job control unit 503 controls the execution of a job.

According to an instruction from the job control unit 503, an image processing unit 504 processes image data into a format suitable for the purpose.

According to an instruction from the job control unit 503, a printing processing unit 505 prints an image on a paper medium via the printer I/F 207 and outputs the image.

According to an instruction from the job control unit 503, a reading processing unit 506 reads a set original document via the scanner I/F 208.

According to an instruction from each control unit, a network control unit 507 inputs and outputs data from and to a LAN or a public line network via the network I/F 204. The network control unit 507 enables an external device to access data stored in the flash ROM 210 via the data storage unit 502. Image data in the PDF or JPEG format is an example of the data stored in the flash ROM 210.

A reservation scan control unit 508 generates a reservation scan instruction from the client terminal 130 received from the network control unit 507 as a reservation scan job. The reservation scan control unit 508 also displays a reservation scan job on the operation unit 102 via the operation control unit 501. The reservation scan control unit 508 also transmits image data read by the reading processing unit 506 executing a reservation scan job to the storage server 120 via the network control unit 507.

An authentication control unit 509 can enable or disable a user authentication function for user authentication for the MFP 100. The authentication control unit 509 manages authentication information such as a user allowed to access the MFP 100 and a password.

A scanning ability management unit 510 manages ability information regarding scanning, such as a reading size, a color mode, and a file type with which the MFP 100 can perform scanning.

In the present exemplary embodiment, software executed by the client terminal 130 is all executed after the CPU 401 reads a program saved in the flash ROM 406 into the DRAM 402. This achieves the function of the reservation scan app 131 in FIG. 1.

Software executed by the authorization server 110 is all executed after the CPU 301 of the authorization server 110 reads a program saved in the HDD 306 into the DRAM 302. This achieves the function of the authorization app 111 in FIG. 1.

Software executed by the storage server 120 is all executed after the CPU 301 of the storage server 120 reads a program saved in the HDD 306 into the DRAM 302. This achieves the function of the storage app 121 in FIG. 1.

The outline of the operation according to the present exemplary embodiment is described below.

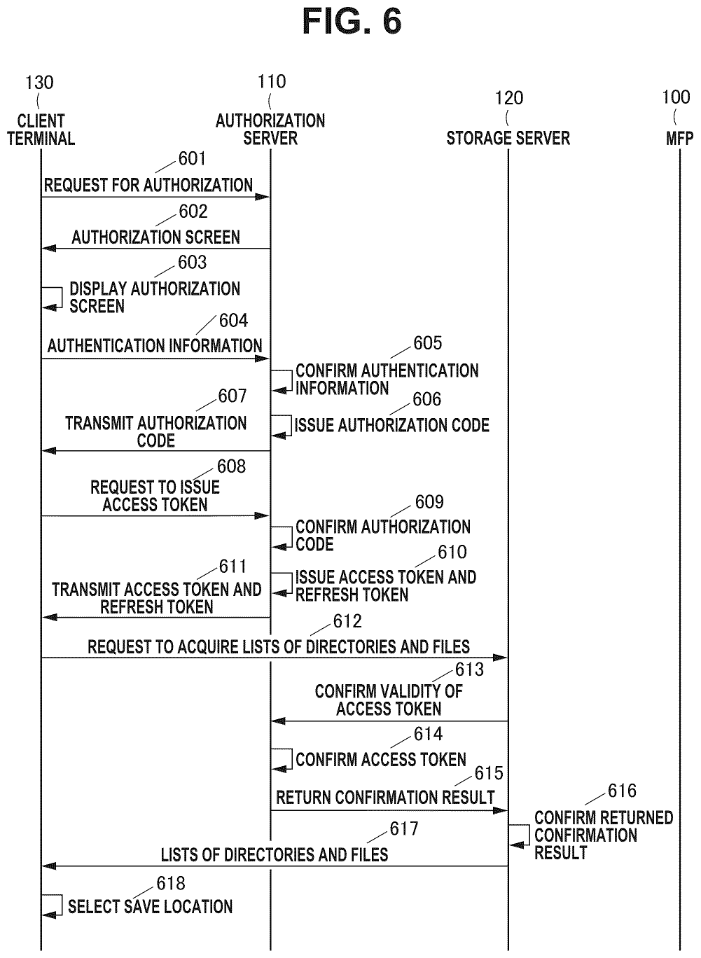

FIG. 6 is a diagram illustrating an example of a sequence in which the reservation scan app 131 of the client terminal 130 acquires an access token to access the storage server 120 and sets a save location for reservation scan. The processing of the client terminal 130 in FIG. 6 is executed by a function achieved by the CPU 401 of the client terminal 130 reading a program stored in the flash ROM 406 into the DRAM 402 and executing the program. The processing of the authorization server 110 is executed by functions achieved by the CPU 301 of the authorization server 110 reading programs stored in the HDD 306 into the DRAM 302 and executing the programs. The processing of the storage server 120 is executed by functions achieved by the CPU 301 of the storage server 120 reading programs stored in the HDD 306 into the DRAM 302 and executing the programs.

If the user starts an operation of starting to set a save location in the storage server 120 in the client terminal 130, then according to the detection of the operation, the client terminal 130 executes the process of step S601.

In step S601, the reservation scan app 131 of the client terminal 130 transmits a request for authorization for access to storage in the storage server 120 to the authorization server 110. According to the request, the authorization app 111 of the authorization server 110 executes the process of step S602.

In step S602, the authorization app 111 of the authorization server 110 instructs the reservation scan app 131 of the client terminal 130 to display an authorization screen. According to the instruction, the reservation scan app 131 of the client terminal 130 executes the process of step S603.

Although this is not the essence of the present disclosure and therefore is not described, authority for the reservation scan app 131 of the client terminal 130 to access the storage server 120 is requested in advance.

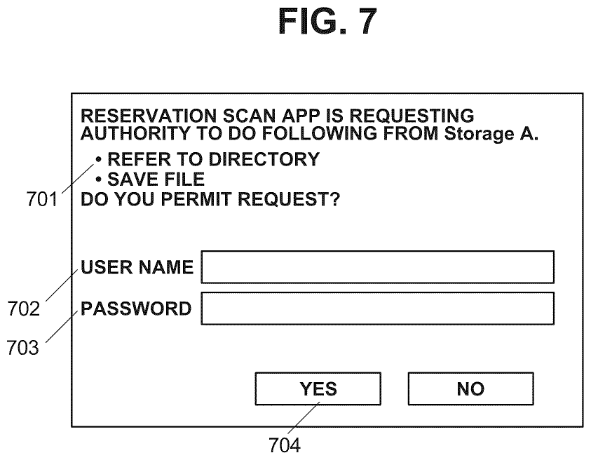

In step S603, the reservation scan app 131 of the client terminal 130 displays an authorization screen as illustrated in FIG. 7, for example.

FIG. 7 is a diagram illustrating an example of the authorization screen according to the present exemplary embodiment.

As illustrated in FIG. 7, on the authorization screen, display (701) of authority over the storage server 120, a user name entry field (702), and a password entry field (703) exist. In a case where the user permits the reservation scan app 131 to access the storage server 120, the user inputs a user name to the user name entry field (702) and a password to the password entry field (703) and performs an operation of pressing a “Yes” button. The screen in FIG. 7 is merely an example, and may display other information so long as the present exemplary embodiment can be achieved. If the user chooses not to permit the access, re-authentication or an error process is performed. However, this is not the essence of the present exemplary embodiment and therefore is not described.

If an operation of permitting the access is performed on the authorization screen displayed in step S603, the reservation scan app 131 of the client terminal 130 having detected the operation executes the process of step S604.

In step S604, the reservation scan app 131 of the client terminal 130 transmits a user name and a password input as authentication information on the authorization screen displayed in step S603 to the authorization server 110. The authorization app 111 of the authorization server 110 having received the authentication information (the user name and the password) executes the process of step S605.

In step S605, using an authentication information DB (not illustrated), the authorization app 111 of the authorization server 110 confirms whether the authentication information transmitted from the client terminal 130 in step S604 is proper. For example, the authentication information DB stores a combination of a user name and a password, and the authorization app 111 of the authorization server 110 confirms whether the combination matches the transmitted authentication information.

Next, in step S606, if it is confirmed that the authentication information received from the client terminal 130 is proper in the confirmation of the authentication information in step S605, the authorization app 111 of the authorization server 110 issues an authorization code.

In step S607, the authorization app 111 of the authorization server 110 transmits the authorization code issued in step S606 to the client terminal 130. The reservation scan app 131 of the client terminal 130 having received the authorization code executes the process of step S608.

In step S608, the reservation scan app 131 of the client terminal 130 transmits the acquired authorization code to the authorization server 110 and makes a request to issue an access token. The authorization app 111 of the authorization server 110 having received the request executes the process of step S609.

In step S609, the authorization app 111 of the authorization server 110 confirms whether the authorization code transmitted from the client terminal 130 in step S608 is valid.

Next, in step S610, if the authorization code transmitted from the client terminal 130 is valid, the authorization app 111 of the authorization server 110 issues an access token and a refresh token.

Next, in step S611, the authorization app 111 of the authorization server 110 transmits the access token and the refresh token issued in step S610 to the client terminal 130. The reservation scan app 131 of the client terminal 130 having received the access token and the refresh token executes the process of step S612.

In step S612, the reservation scan app 131 of the client terminal 130 transmits the access token received in step S611 to the storage server 120 and makes a request to acquire lists of directories and files. The storage app 121 of the storage server 120 having received the request executes the process of step S613.

In step S613, the storage app 121 of the storage server 120 confirms with the authorization server 110 whether the access token received from the client terminal 130 is valid. The authorization app 111 of the authorization server 110 having received the access token executes the process of step S614.

In step S614, the authorization app 111 of the authorization server 110 confirms the validity of the access token received from the storage server 120 in step S613.

Next, in step S615, the authorization app 111 of the authorization server 110 returns the confirmation result of the access token to the storage server 120. The storage app 121 of the storage server 120 having received the confirmation result executes the process of step S616.

In step S616, the storage app 121 of the storage server 120 confirms the confirmation result of the access token returned from the authorization server 110.

In this sequence, only a case where the access token is valid is described below, and a case where the access token is invalid is not described. For example, if the access token is invalid, although not illustrated, an error process is performed.

If the access token is valid, then in step S617, the storage app 121 of the storage server 120 returns lists of files and directories in the storage server 120 to the client terminal 130. The reservation scan app 131 of the client terminal 130 having received the lists executes the process of step S618.

In step S618, the reservation scan app 131 of the client terminal 130 displays the list of directories in the storage server 120 on an operation unit (not illustrated) of the client terminal 130 and urges the user operating the client terminal 130 to select a save location.

If an operation of selecting a save location is performed, the reservation scan app 131 of the client terminal 130 receives information regarding the selected save location.

In the present exemplary embodiment, an example is illustrated where in step S617, lists of files and directories in the storage server 120 are returned only once. However, to move the hierarchical level of a directory, a file in the directory at the movement destination and a list of directories after the movement may be returned, whereby the client terminal 130 and the storage server 120 may exchange information with each other multiple times. Although in the description of FIG. 7, an example has been illustrated where an authorization code is used, as a matter of course, an access token may be issued using another method. In this sequence, for ease of description, the confirmation of whether the authorization code or the access token expires is not described. However, the authorization code or the access token does not need to be acquired every time. It may be confirmed whether the authorization code or the access token expires, and only if the authorization code or the access token expires, the authorization code or the access token may be acquired.

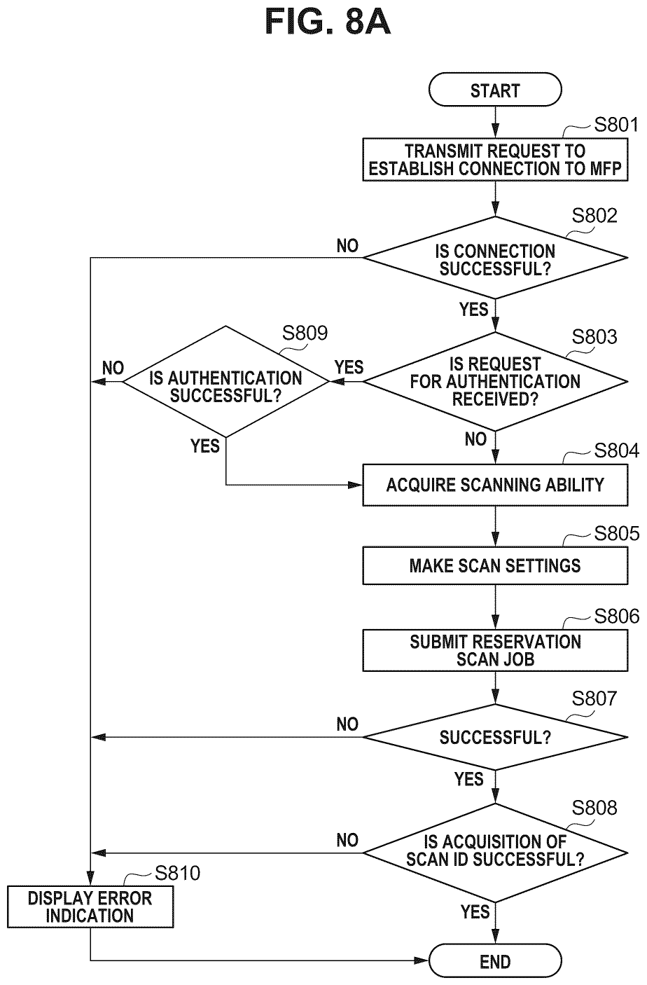

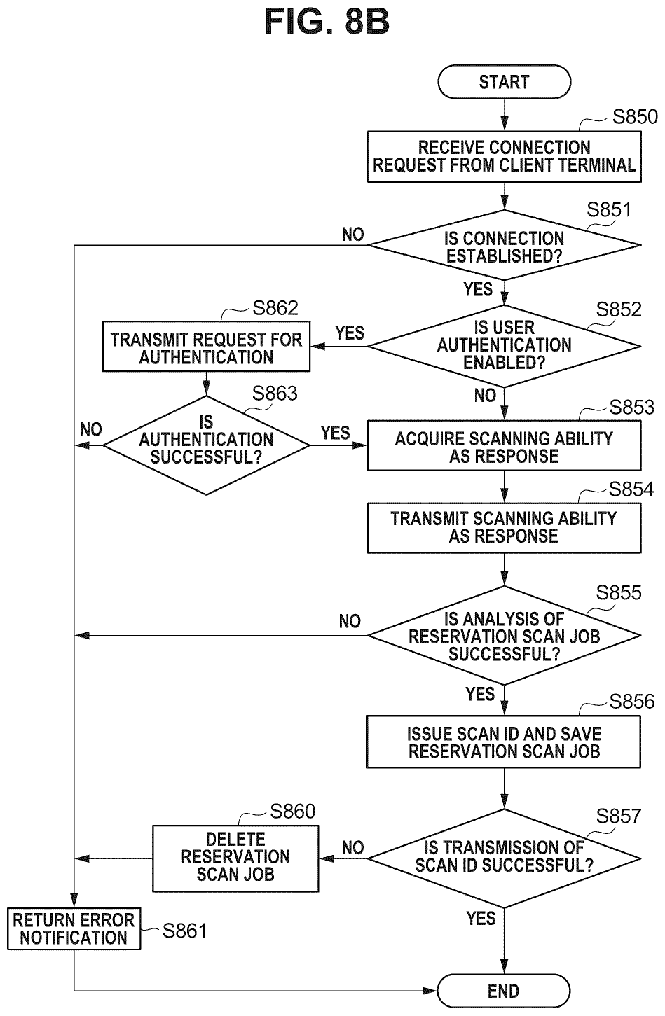

With reference to FIG. 8A, a description is given of a process in which the client terminal 130 transmits a reservation scan job to the MFP 100 according to the first exemplary embodiment.

FIG. 8A is a flowchart illustrating an example of the process in which the client terminal 130 transmits a reservation scan job to the MFP 100 according to the first exemplary embodiment. The processing of the client terminal 130 in FIG. 8A is executed by a function achieved by the CPU 401 of the client terminal 130 reading a program stored in the flash ROM 406 into the DRAM 402 and executing the program. If the user performs an operation of executing the reservation scan app 131 in the client terminal 130, the reservation scan app 131 of the client terminal 130 starts the processing of this flowchart.

In step S801, the reservation scan app 131 transmits a request to establish a connection to the MFP 100.

Next, in step S802, the reservation scan app 131 receives the result of the request to establish a connection from the MFP 100, and based on the result, determines whether a connection to the MFP 100 is successful. If it is determined that a connection to the MFP 100 fails (No in step S802), then in step S810, the reservation scan app 131 displays an error indication on the operation unit of the client terminal 130 via the panel I/F 407, and the processing of this flowchart ends.

If, on the other hand, it is determined that a connection to the MFP 100 is successful (Yes in step S802), the processing proceeds to step S803.

In step S803, the reservation scan app 131 determines whether authentication for access from the MFP 100 is required (a request for authentication is received from the MFP 100). If it is determined that the authentication is not required (No in step S803), the processing proceeds to step S804.

If, on the other hand, it is determined that the authentication is required (Yes in step S803), the processing proceeds to step S809.

In step S809, the reservation scan app 131 displays an authentication screen (not illustrated) on the operation unit of the client terminal 130 via the panel I/F 407 and urges the user to input information such as a user name and a password required for the authentication (authentication information). If the user inputs authentication information, the reservation scan app 131 transmits the input authentication information to the MFP 100 and attempts to authenticate the MFP 100. If the authentication fails (No in step S809), then in step S810, the reservation scan app 131 displays an error indication on the operation unit of the client terminal 130 via the panel I/F 407, and the processing of this flowchart ends.

If, on the other hand, the authentication is successful (Yes in step S809), the processing proceeds to step S804.

In step S804, if the reservation scan app 131 acquires the scanning ability of the MFP 100 transmitted from the MFP 100, the processing proceeds to step S805. In the acquisition of the scanning ability of the MFP 100, the reservation scan app 131 acquires information required for scan settings such as a reading size, a color mode, and a file type with which the MFP 100 can perform scanning.

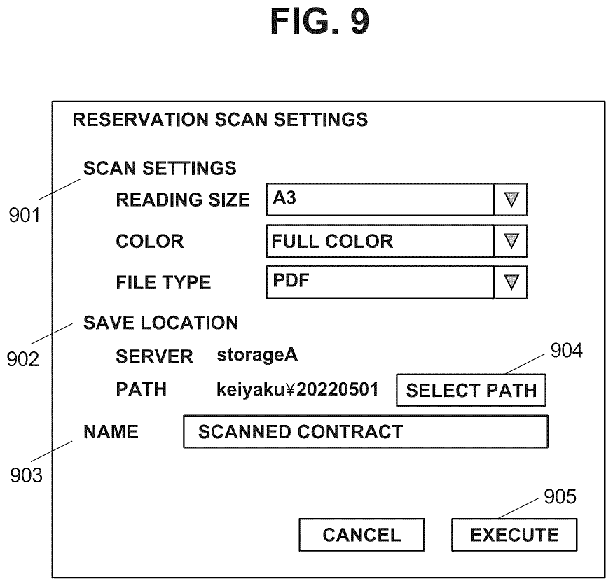

In step S805, the reservation scan app 131 displays a “reservation scan settings” screen as illustrated in FIG. 9 on the operation unit of the client terminal 130 via the panel I/F 407 and urges the user to make scan settings. The “reservation scan settings” screen is described.

FIG. 9 is a diagram illustrating an example of the “reservation scan settings” screen according to the present exemplary embodiment.

The “reservation scan settings” screen displays the reading size, the color mode, and the file type according to the scanning ability acquired in step S804 in FIG. 8A as scan settings 901. The “reservation scan settings” screen also displays settings such as a path 902 (will be also referred to as a save location 902) to a save location in the storage server 120 and a name 903 of a reservation scan job.

A “select path” button 904 is a button for selecting the path to the save location in the storage server 120. If the “select path” button 904 is pressed, the reservation scan app 131 acquires an access token according to the sequence as illustrated in FIG. 6, displays a screen (not illustrated) for a list of directories in the storage server 120, and enables the user to select the path to the save location.

The settings illustrated in FIG. 9 are merely examples, and another setting may be able to be made, or only some of the settings may be made so long as the present exemplary embodiment can be achieved. For example, a setting other than those illustrated in FIG. 9 may be able to be made as a scan setting, or the name of the reservation scan job may not be able to be set. In the present exemplary embodiment, the storage server 120 as the save location and the MFP 100 as the transmission destination of the reservation scan job are specified in advance in the client terminal 130. The storage server 120 and the MFP 100, however, may not be specified in advance in the client terminal 130, and the storage server 120 and the MFP 100 may be able to be selected on the screen in FIG. 9.

The “reservation scan settings” screen also includes an “execute” button 905. If the “execute” button 905 is pressed, the reservation scan app 131 executes the process of step S806 in FIG. 8A.

In step S806, the reservation scan app 131 transmits the scan settings 901, the save location 902, the name 903 of the reservation scan job, the access token, and the user name (if the authentication process is performed in step S809 in FIG. 8A) to the MFP 100 via the network I/F 404 and submits the reservation scan job.

Next, in step S807, the reservation scan app 131 determines whether the submission of the reservation scan job is successful. If the submission of the reservation scan job fails (No in step S807), then in step S810, the reservation scan app 131 displays an error indication on the operation unit of the client terminal 130 via the panel I/F 407, and the processing of this flowchart ends.

If, on the other hand, the submission of the reservation scan job is successful (Yes in step S807), the processing proceeds to step S808.

In step S808, the reservation scan app 131 waits for a scan identifier (ID) regarding the reservation scan job submitted in step S806 to be transmitted from the MFP 100. If the reservation scan app 131 receives an error notification from the MFP 100, the reservation scan app 131 determines that the acquisition of a scan ID fails (No in step S808), and in step S810, the reservation scan app 131 displays an error indication on the operation unit of the client terminal 130 via the panel I/F 407, and the processing of this flowchart ends.

If, on the other hand, the reservation scan app 131 receives a scan ID from the MFP 100 (Yes in step S808), the reservation scan app 131 displays the received scan ID on the operation unit of the client terminal 130 via the panel I/F 407 (a step not illustrated), and the processing of this flowchart ends.

Next, with reference to a flowchart in FIG. 8B, a description is given of a process in which the MFP 100 receives a reservation scan job according to the first exemplary embodiment.

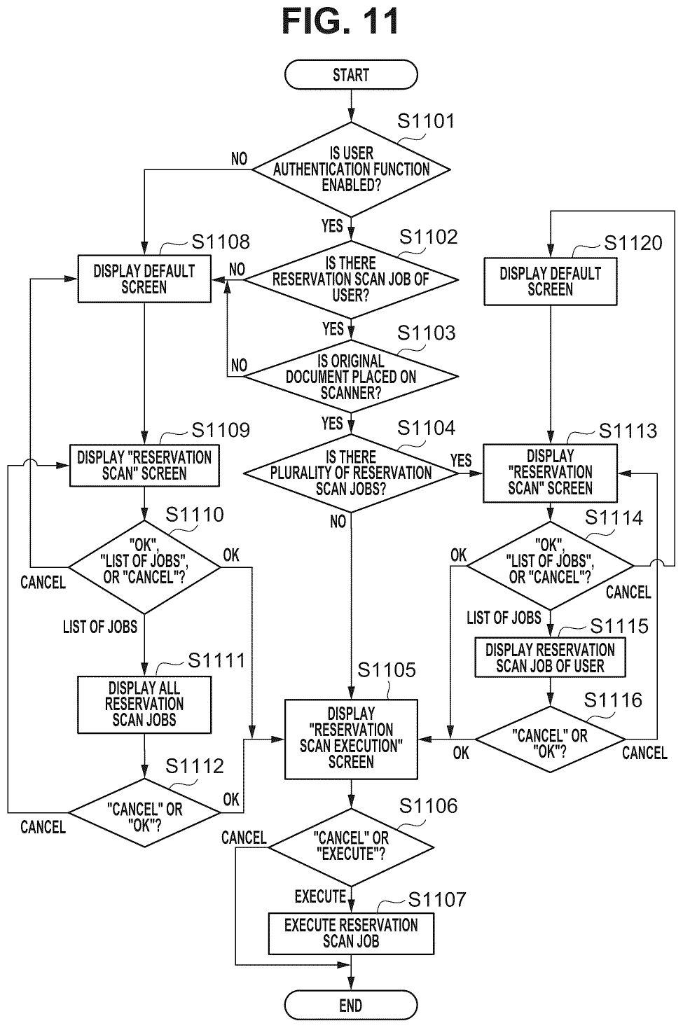

FIG. 8B is a flowchart illustrating an example of the process in which the MFP 100 receives a reservation scan job according to the first exemplary embodiment. The processing illustrated in FIGS. 8B and 11 is executed by functions achieved by the CPU 201 of the MFP 100 reading programs saved in the flash ROM 210 into the DRAM 202 and executing the programs.

When the MFP 100 starts, the MFP 100 starts the functions as illustrated in FIG. 5 and enters the state where the MFP 100 can receive a connection request as illustrated in step S801 in FIG. 8A via the network control unit 507. In step S850, if the MFP 100 receives a connection request as illustrated in step S801 in FIG. 8A via the network control unit 507, the processing proceeds to step S851.

In step S851, according to the connection request in step S850, the MFP 100 attempts to connect to the client terminal 130. If a connection to the client terminal 130 fails (No in step S851), then in step S861, the MFP 100 returns an error notification to the client terminal 130 via the network control unit 507, and the processing of this flowchart ends.

If, on the other hand, a connection to the client terminal 130 is successful (Yes in step S851), the processing proceeds to step S852.

In step S852, the reservation scan control unit 508 acquires, from the authentication control unit 509, information regarding whether the user authentication is enabled. If the user authentication is disabled (No in step S852), the processing proceeds to step S853.

If, on the other hand, the user authentication is enabled (Yes in step S852), the processing proceeds to step S862.

In step S862, the reservation scan control unit 508 transmits, via the network control unit 507, a request for authentication to the client terminal 130 to which the connection is established in step S851.

Next, in step S863, if the reservation scan control unit 508 receives authentication information (step S809 in FIG. 8A) transmitted from the client terminal 130 via the network control unit 507 according to the request for authentication, the reservation scan control unit 508 transmits the authentication information to the authentication control unit 509, thereby requesting the authentication control unit 509 to perform authentication. Further, the reservation scan control unit 508 determines whether the authentication is successful in the authentication control unit 509. If the authentication fails (No in step S863), then in step S861, the reservation scan control unit 508 returns an error notification to the client terminal 130 via the network control unit 507, and the processing of this flowchart ends.

If, on the other hand, the authentication is successful (Yes in step S863), the processing proceeds to step S853.

In step S853, the reservation scan control unit 508 acquires the scanning ability such as a reading size, a color mode, and a file type from the scanning ability management unit 510.

Next, in step S854, the reservation scan control unit 508 transmits, via the network control unit 507, the scanning ability acquired in step S853 to the client terminal 130 to which the connection is established.

Next, in step S855, the reservation scan control unit 508 waits for a reservation scan job (step S806 in FIG. 8A) to be transmitted from the client terminal 130. If the reservation scan control unit 508 receives a reservation scan job as illustrated in step S806 via the network control unit 507, the reservation scan control unit 508 analyzes the reservation scan job. If the analysis fails (No in step S855), then in step S861, the reservation scan control unit 508 returns an error notification to the client terminal 130 via the network control unit 507, and the processing of this flowchart ends.

If, on the other hand, the analysis of the reservation scan job is successful (Yes in step S855), the processing proceeds to step S856.

In step S856, the reservation scan control unit 508 issues a scan ID (identification information regarding the reservation scan job) for the received reservation scan job and saves the scan ID together with the reservation scan job (by associating the scan ID and the reservation scan job) in the data storage unit 502, thereby reserving the scan job.

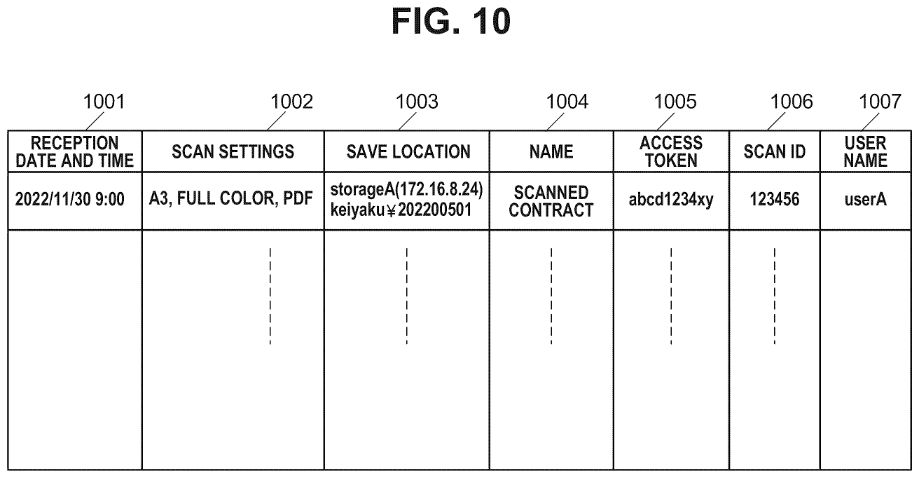

FIG. 10 is a diagram illustrating an example of a data format when the reservation scan job according to the present exemplary embodiment is saved in the data storage unit 502.

In step S856, as the reservation scan job, scan settings 1002, a save location 1003, a name 1004, an access token 1005, a scan ID 1006, a reception date and time 1001, and a user name 1007 are saved.

In the reception date and time 1001, the job reception date and time when the reservation scan job is received in step S855 is saved. In the scan settings 1002, the save location 1003, and the name 1004, the scan settings 901, the save location 902, and the reservation scan job name 903, respectively, set on the “reservation scan settings” screen illustrated in FIG. 9 are saved. Further, in the access token 1005, the access token acquired by the reservation scan app 131 when the save location 902 is set in the reservation scan settings is saved. In the scan ID 1006, the scan ID generated in step S856 is saved. If the user authentication in step S863 is executed, the user name used in the user authentication is saved in the user name 1007.

The description returns to FIG. 8B below.

Next, in step S857, the reservation scan control unit 508 transmits, via the network control unit 507, the scan ID generated in step S856 to the client terminal 130 to which the connection is established in step S851 (the transmission source of the reservation scan job received in step S855). If the transmission of the scan ID fails (No in step S857), then in step S860, the reservation scan control unit 508 deletes the reservation scan job received in step S855. In step S861, the reservation scan control unit 508 returns an error notification to the client terminal 130 via the network control unit 507, and the processing of this flowchart ends.

If, on the other hand, the transmission of the scan ID is successful (Yes in step S857), the processing of this flowchart ends.

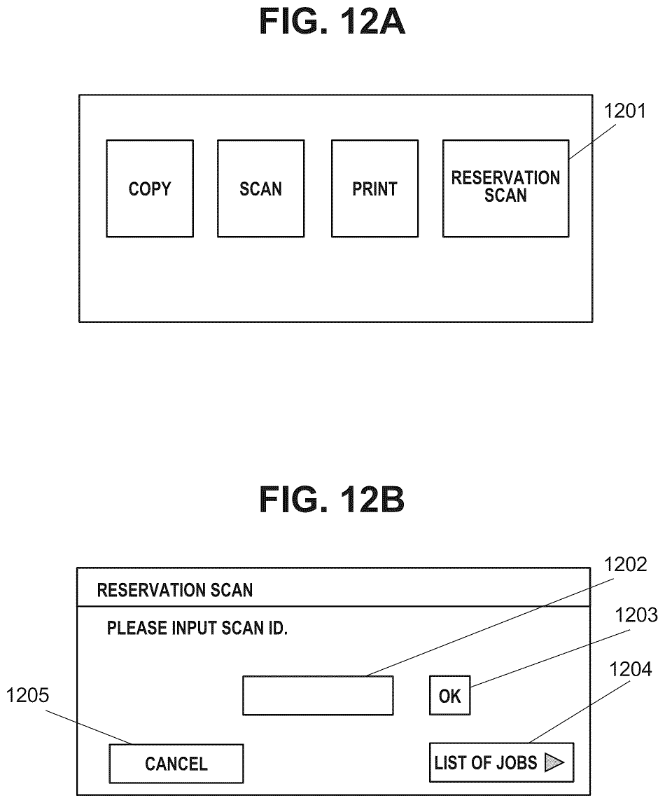

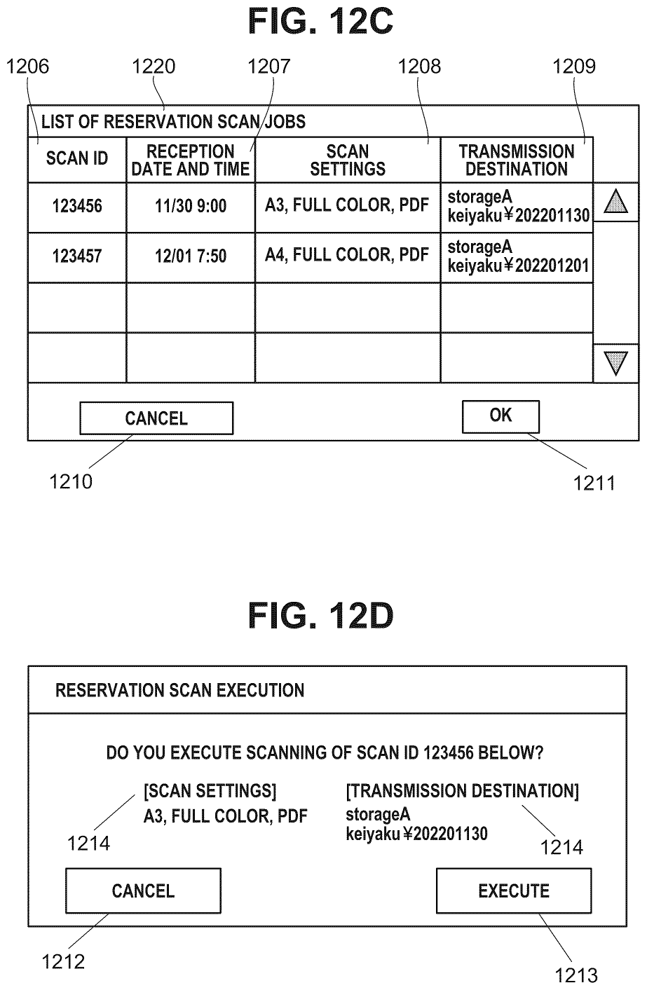

With reference to FIGS. 11, 12A, and 12B, a description is given of a process in which the MFP 100 executes a reservation scan job according to the present exemplary embodiment.

FIG. 11 is a flowchart illustrating an example of the process in which the MFP 100 executes a reservation scan job according to the present exemplary embodiment.

FIGS. 12A and 12B are diagrams illustrating examples of screens when a reservation scan job is executed according to the present exemplary embodiment. Hereinafter, FIGS. 12A and 12B will be collectively referred to as “FIG. 12”.

If the user performs an operation on the operation unit 102 of the MFP 100, the MFP 100 starts the processing illustrated in FIG. 11.

In step S1101, when the MFP 100 is operated, the reservation scan control unit 508 of the MFP 100 acquires, from the authentication control unit 509, information regarding whether the user authentication function is enabled. If the user authentication function is disabled (No in step S1101), the processing proceeds to step S1108.

In step S1108, the operation control unit 501 displays a default display screen as illustrated in FIG. 12A on the operation unit 102.

If the operation control unit 501 detects that a “reservation scan” button 1201 on the default display screen is pressed, the processing proceeds to step S1109. The processing in a case where a button other than the “reservation scan” button 1201 is pressed is not described.

In step S1109, the operation control unit 501 displays a “reservation scan” screen as illustrated in FIG. 12B on the operation unit 102.

As illustrated in FIG. 12B, the “reservation scan” screen includes a scan ID entry field 1202, an “OK” button 1203, a “list of jobs” button 1204, and a “cancel” button 1205.

In step S1110, the operation control unit 501 performs control according to a user operation on the “reservation scan” screen.

If the operation control unit 501 detects that the “cancel” button 1205 is pressed (“cancel” in step S1110), the processing returns to step S1108.

If the user inputs a scan ID to the scan ID entry field 1202 and presses the “OK” button 1203 (“OK” in step S1110), the processing proceeds to step S1105.

In step S1105, the reservation scan control unit 508 searches for (identifies) a reservation scan job that matches the scan ID input to the scan ID entry field 1202 among the reservation scan jobs as illustrated in FIG. 10. Then, the reservation scan control unit 508 instructs the operation control unit 501 to display the reservation scan job that matches the scan ID on a “reservation scan execution” screen as illustrated in FIG. 12D. Consequently, information regarding the reservation scan job that matches the input scan ID is displayed on the “reservation scan execution” screen via the operation control unit 501. The “reservation scan execution” screen in FIG. 12D is merely an example, and may display information other than the scan ID, the scan settings, and the transmission destination. Next, the processing proceeds to step S1106. Although not illustrated in FIG. 11, if there is not information regarding the reservation scan job that matches the input scan ID, the reservation scan control unit 508 displays a message indicating this state on the operation unit 102 via the operation control unit 501. According to a confirmation operation of the user on the screen, the processing proceeds to step S1109.

As illustrated in FIG. 12D, the “reservation scan execution” screen includes information 1214 regarding the reservation scan job that matches the input scan ID, an “execute” button 1213, and a “cancel” button 1212.

If the operation control unit 501 detects a user operation on the “reservation scan execution” screen, then in step S1106, the operation control unit 501 performs control according to the user operation.

If the operation control unit 501 detects that the “cancel” button 1212 is pressed (“cancel” in step S1106), the processing of this flowchart ends.

If the operation control unit 501 detects that the “execute” button 1213 is pressed (“execute” in step S1106), the processing proceeds to step S1107.

In step S1107, the operation control unit 501 transmits an instruction to execute the reservation scan job to the reservation scan control unit 508. If the reservation scan control unit 508 receives the instruction to execute the reservation scan job from the operation control unit 501, the reservation scan control unit 508 gives a scanning instruction to the reading processing unit 506 to perform scanning with settings according to the scan settings made in the reservation scan job. Consequently, the reading processing unit 506 executes scanning. Then, if the reservation scan control unit 508 detects that the scanning is completed, the reservation scan control unit 508 performs authorization in the authorization server 110 via the network control unit 507 using the access token 1005 set in the reservation scan job and transmits a scanned document to the storage server 120 specified in the save location 1003. Then, if the storage server 120 specified in the save location 1003 receives scan data (hereinafter referred to as a “scan document”) transmitted from the MFP 100, the storage server 120 saves the received scan document in the specified save location.

In step S1110, if the operation control unit 501 detects that the “list of jobs” button 1204 is pressed on the “reservation scan” screen as illustrated in FIG. 12B (“list of jobs” in step S1110), the processing proceeds to step S1111.

In step S1111, the operation control unit 501 acquires all reservation scan jobs via the reservation scan control unit 508 and displays a “list of reservation scan jobs” screen as illustrated in FIG. 12C.

As illustrated in FIG. 12C, the “list of reservation scan jobs” screen includes reservation scan job list display 1220, an “OK” button 1211, and a “cancel” button 1210. In the reservation scan job list display 1220, the user can select a reservation scan job from the list and can also select a plurality of reservation scan jobs. As an example of the reservation scan job list display 1220, information such as a scan ID 1206, a reception date and time 1207 of a reservation scan job, scan settings 1208, and a transmission destination 1209 is displayed. Alternatively, other information may be displayed.

In step S1112, if the operation control unit 501 detects a user operation on the “list of reservation scan jobs” screen as illustrated in FIG. 12C, the operation control unit 501 performs control according to the user operation.

If the operation control unit 501 detects that the “cancel” button 1210 is pressed (“cancel” in step S1112), the operation control unit 501 cancels the selection of a reservation scan job, and the processing returns to step S1109.

If, on the other hand, the operation control unit 501 detects that one or more reservation scan jobs are selected and the “OK” button 1211 is pressed (“OK” in step S1112), the processing proceeds to step S1105. In this case, in step S1105, the reservation scan control unit 508 identifies one or more reservation scan jobs selected on the “list of reservation scan jobs” screen as illustrated in FIG. 12C and instructs the operation control unit 501 to display the identified reservation scan jobs on the “reservation scan execution” screen as illustrated in FIG. 12D. Other processes are as described above.

In step S1101, if the reservation scan control unit 508 determines that the user authentication function is enabled (Yes in step S1101), then after the user succeeds in logging in via user authentication, the processing proceeds to step S1102. The processing in a case where the user fails to log in is not described.

In step S1102, the reservation scan control unit 508 searches for a reservation scan job that matches the user name of the user operating the MFP 100 (the logged-in user) among the reservation scan jobs illustrated in FIG. 10.

If there is not a reservation scan job that matches the user name (No in step S1102), the processing proceeds to step S1108. The processes of step S1108 and the subsequent steps are as described above.

If, on the other hand, there is a reservation scan job that matches the user name of the user operating the MFP 100 (Yes in step $1102), the processing proceeds to step S1103.

In step S1103, the reservation scan control unit 508 detects whether an original document is placed on the scanner unit 104, via the reading processing unit 506.

If it is determined that an original document is not placed (No in step S1103), the processing proceeds to step S1108.

If, on the other hand, the reservation scan control unit 508 detects that an original document is placed (Yes in step S1103), the processing proceeds to step S1104.

In step S1104, the reservation scan control unit 508 determines whether there is a plurality of reservation scan jobs found in step S1102.

If there is not a plurality of reservation scan jobs (No in step S1104), the processing proceeds to step S1105.

If, on the other hand, there is a plurality of reservation scan jobs (Yes in step S1104), the processing proceeds to step S1113.

In step S1113, the operation control unit 501 displays the “reservation scan” screen as illustrated in FIG. 12B on the operation unit 102.

In step S1114, the operation control unit 501 performs control according to a user operation on the “reservation scan” screen.

If the operation control unit 501 detects that the “cancel” button 1205 is pressed (“cancel” in step S1114), the processing returns to step S1120.

In step S1120, the operation control unit 501 displays the default display screen as illustrated in FIG. 12A on the operation unit 102. If the operation control unit 501 detects that the “reservation scan” button 1201 is pressed, the processing proceeds to step S1113. The processing in a case where a button other than the “reservation scan” button 1201 is pressed is not described.

In step S1114, if the operation control unit 501 detects that a scan ID is input to the scan ID entry field 1202 and the “OK” button 1203 is pressed on the “reservation scan” screen as illustrated in FIG. 12B (“OK” in step S1114), the processing proceeds to step S1105. In this case, in step S1105, the reservation scan control unit 508 searches for (identifies) a reservation scan job that matches the scan ID input to the scan ID entry field 1202 among the reservation scan jobs saved in association with user information regarding the user logged in by the login operation. Then, the reservation scan control unit 508 instructs the operation control unit 501 to display the reservation scan job that matches the scan ID on the “reservation scan execution” screen as illustrated in FIG. 12D. Other processes are as described above.

In step S1114, if the operation control unit 501 detects that the “list of jobs” button 1204 is pressed on the “reservation scan” screen (“list of jobs” in step S1114), the processing proceeds to step S1115.

In step S1115, the operation control unit 501 identifies and acquires only a reservation scan job that matches the user name of the user operating the MFP 100 (the user information regarding the user logged in by the login operation) among all reservation scan jobs via the reservation scan control unit 508. Then, the operation control unit 501 displays the “list of reservation scan jobs” screen as illustrated in FIG. 12C.

If the operation control unit 501 detects a user operation on the “reservation scan execution” screen, then in step S1116, the operation control unit 501 performs control according to the user operation.

If the operation control unit 501 detects that the “cancel” button 1210 is pressed (“cancel” in step S1116), the operation control unit 501 cancels the selection of a reservation scan job, and the processing returns to step S1113.

If, on the other hand, the operation control unit 501 detects that one or more reservation scan jobs are selected and the “OK” button 1211 is pressed (“OK” in step S1116), the processing proceeds to step S1105.

As described above, the MFP 100 receives from the client terminal 130 a scan job including scan settings, the transmission destination of scan data to be read by the MFP 100 based on the scan settings, and a token acquired from the authorization server 110 and for accessing the transmission destination and saves data of the received scan job in a storage unit, thereby reserving the scan job. According to a user operation via the operation unit 102, the MFP 100 also identifies a scan job as a target among jobs reserved in the MFP 100 and executes the scan job. Then, the MFP 100 transmits scan data read by a scanner by the execution of the scan job to a transmission destination included in the scan job using an access token included in the scan job. As described above, according to the first exemplary embodiment, it is possible to directly reserve scan settings made in the client terminal 130 in the MFP 100. Thus, it is not necessary to separately provide an external service on a network, and the user can easily transmit a scanned document to a storage server in a cloud service.

If there is only a single reservation scan job of the authenticated user, the user can submit the reservation scan job by placing an original document on the scanner unit 104. This improves the operability for the user.

In any case, the user can upload a scan document to the storage server 120 by executing a reserved scan job transmitted in advance from the client terminal 130 by a simple user operation via the operation unit 102 of the MFP 100.

That is, with a simple configuration having a low barrier to introduction in which an external service does not need to be separately constructed on a network, it is possible to construct a scanning environment where convenience for uploading a scan document from an image processing apparatus to a storage server is significantly improved.

In a second exemplary embodiment, a configuration is described in which MFPs to which a reservation scan job can be submitted from the reservation scan app 131 of the client terminal 130 are limited, thereby enabling the use of an authentication token only in a reliable MFP.

In the storage server 120 in a cloud service according to the present exemplary embodiment, information regarding a device capable of saving data in the storage server 120 can be registered in advance in the cloud service.

The registration of the information is performed by the administrator of the MFP 100 via the operation unit 102 of the MFP 100 via a network, but may also be able to be performed by a general user.

If the registration of the MFP 100 in the storage server 120 is completed, the MFP 100 saves information indicating that the MFP 100 is registered in the storage server 120 in the flash ROM 210. For example, the MFP 100 is managed based on a record including identification information regarding a cloud service as a target, identification information regarding the storage server 120, and the registration date.

The operations of the apparatuses according to the second exemplary embodiment are described below.

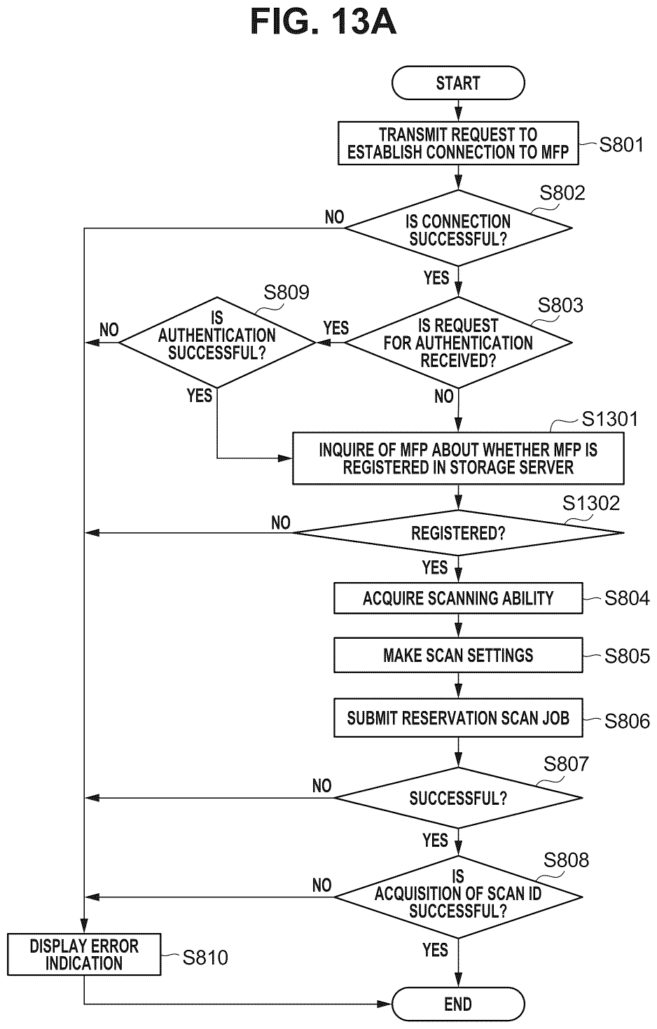

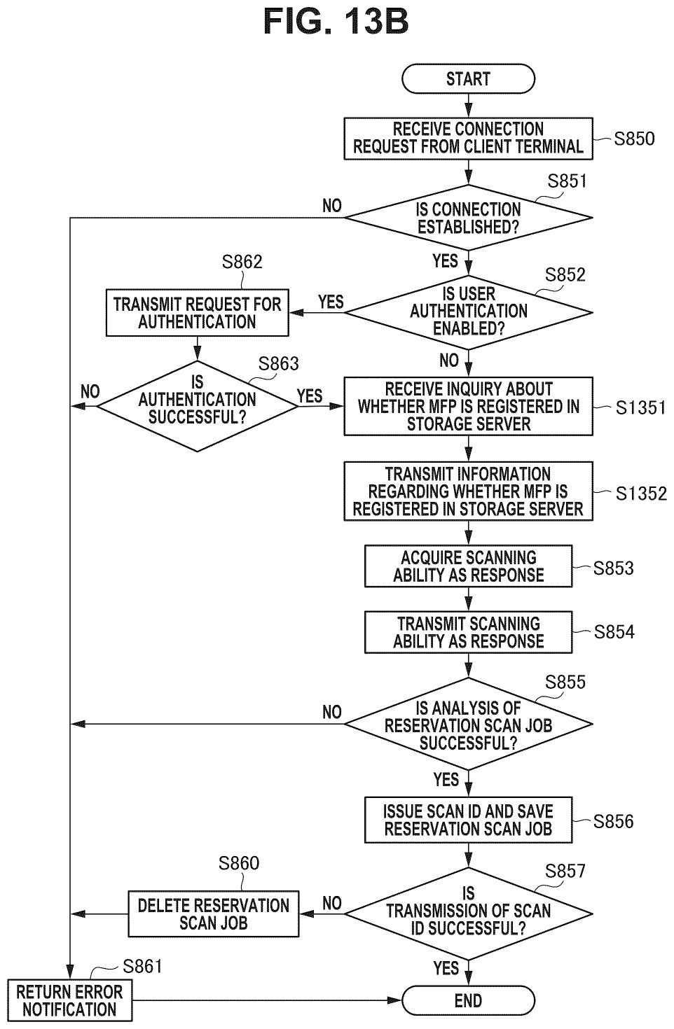

First, with reference to FIG. 13A, a description is given of a process in which the client terminal 130 transmits a reservation scan job to the MFP 100 according to the second exemplary embodiment.

FIG. 13A is a flowchart illustrating an example of the process in which the client terminal 130 transmits a reservation scan job to the MFP 100 according to the second exemplary embodiment. The processing illustrated in FIG. 13A is executed by a function achieved by the CPU 401 of the client terminal 130 reading a program stored in the flash ROM 406 into the DRAM 402 and executing the program. Steps similar to those in FIG. 8A are designated by the same step numbers, and are not described.

In the second exemplary embodiment, if the determination is No in step S803 (No in step S803), the processing proceeds to step S1301. Also if the determination is Yes in step S809 (Yes in step S809), the processing proceeds to step S1301.

In step S1301, the reservation scan app 131 inquires of the MFP 100 about whether the MFP 100 is registered in the storage server 120 as the save location. Then, the reservation scan app 131 acquires a response from the MFP 100.

Next, in step S1302, based on the information acquired in step S1301, the reservation scan app 131 determines whether the MFP 100 is registered in the storage server 120 as the save location.

If it is determined that the MFP 100 is registered in the storage server 120 as the save location (Yes in step S1302), the processing proceeds to step S804.

If, on the other hand, it is determined that the MFP 100 is not registered in the storage server 120 as the save location (No in step S1302), then in step S810, the reservation scan app 131 displays an error indication on the operation unit of the client terminal 130 via the panel I/F 407, and the processing of this flowchart ends. That is, the reservation scan app 131 prohibits an instruction to execute a reservation scan job from being given to the MFP 100.

Next, with reference to a flowchart in FIG. 13B, a description is given of a process in which the MFP 100 receives a reservation scan job according to the second exemplary embodiment.

FIG. 13B is a flowchart illustrating an example of the process in which the MFP 100 receives a reservation scan job according to the second exemplary embodiment. The processing illustrated in FIG. 13B is executed by functions achieved by the CPU 201 of the MFP 100 reading programs saved in the flash ROM 210 into the DRAM 202 and executing the programs. Steps similar to those in FIG. 8B are designated by the same step numbers, and are not described.

In the second exemplary embodiment, if the determination is No in step S852 (No in step S852), the processing proceeds to step S1351. Also if the determination is Yes in step S863 (Yes in step S863), the processing proceeds to step S1351.

In step S1351, if the reservation scan control unit 508 receives an inquiry from the client terminal 130 (an inquiry about whether the MFP 100 is registered in the storage server 120 as illustrated in step S1301 in FIG. 13A), the processing proceeds to step S1352.

In step S1352, the reservation scan control unit 508 transmits information regarding whether the MFP 100 is registered in the storage server 120 to the client terminal 130. Specifically, if information indicating that the MFP 100 is registered in the storage server 120 is saved in the flash ROM 210, the reservation scan control unit 508 transmits information indicating that the MFP 100 is registered. If the information is not saved, the reservation scan control unit 508 transmits information indicating that the MFP 100 is not registered.

As described above, according to the second exemplary embodiment, it is possible to enable the use of an access token for accessing the storage server 120 only in a reliable image processing apparatus. That is, it is possible to prohibit the use of an access token in an image processing apparatus of which the reliability cannot be guaranteed.

Although in the exemplary embodiments, a description has been given using an MFP as an example of an image processing apparatus including a scanner, a network scanner may be used.

As described above, according to the exemplary embodiments, with a simple configuration having a low barrier to introduction in which an external service does not need to be separately constructed on a network, a user can easily transmit a scan document from an image processing apparatus such as an MFP to a cloud service. Thus, it is possible to significantly improve convenience.

According to the present disclosure, with a simple configuration having a low barrier to introduction in which an external service does not need to be separately constructed on a network, a user can easily transmit a scan document from an image processing apparatus such as an MFP to a cloud service. Thus, it is possible to significantly improve convenience.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-011044, filed Jan. 29, 2024, which is hereby incorporated by reference herein in its entirety.

What is claimed is:

1. An image processing apparatus comprising:
a scanner;
a storage device configured to save one or more jobs;
one or more memories storing a program; and
one or more processors, that when executing the program, cause the image processing apparatus to:
receive, from an information processing apparatus, a scan job including a scan setting, a transmission destination of image data to be obtained in a reading process by the scanner based on the scan setting and a token acquired from an authorization server to access the transmission destination;
save the received scan job in the storage device;
identify, based on a user operation via an operation unit of the image processing apparatus, a target scan job from the storage device; and
execute a transmission process based on image data obtained by executing the identified scan job and a token and a transmission destination included in the identified scan job.

2. The image processing apparatus according to claim 1,
wherein the one or more processors further cause the image processing apparatus to transmit identification information issued to identify a scan job saved in the storage device to the information processing apparatus as a transmission source of the scan job,
wherein the scan job is saved in association with the issued identification information in the storage device, and
wherein the user operation is an operation of identifying the identification information for identifying the target scan job.

3. The image processing apparatus according to claim 1,
wherein the scan job is saved in association with user information in the storage device, and
wherein the scan job saved in association with the user information regarding a user logged in by a login operation on the image processing apparatus in the storage device is identified as the target scan job.

4. The image processing apparatus according to claim 1,
wherein the one or more processors further cause the image processing apparatus to transmit registration information indicating that information regarding the image processing apparatus is registered in a predetermined storage service to the information processing apparatus, and
wherein a scan job received from the information processing apparatus after the transmission of the registration information and including scan settings, a transmission destination corresponding to the predetermined storage service, and a token for accessing the transmission destination is saved in the storage device.

5. A method for controlling an image processing apparatus including a scanner and a storage device configured to save one or more jobs, the method comprising:
receiving, from an information processing apparatus, a scan job including a scan setting, a transmission destination of image data to be obtained in a reading process by the scanner based on the scan setting, and a token acquired from an authorization server to access the transmission destination;
saving the received scan job in the storage device;
identifying, based on a user operation via an operation unit of the image processing apparatus, a target scan job from the storage device; and
executing a transmission process based on image data obtained by executing the identified scan job and a token and a transmission destination included in identified the scan job.
